(19) United States
(12) Patent Application Publication
(10) Pub. No.: US 2008/0078942 A1
(43) Pub. Date: Apr. 3, 2008

(54) Particle therapy system

(76) Inventor: Eike Rietzel, Darmstadt (DE)

Correspondence Address: BRINKS HOFER GILSON & LIONE, P.O. BOX 10395, CHICAGO, IL, 60610, US

(21) Appl. No.: 11/903,301

(22) Filed: Sep. 21, 2007

Related U.S. Application Data
(60) Provisional application No. 60/848,602, filed on Sep. 29, 2006.

(30) Foreign Application Priority Data
Sep. 29, 2006 (DE) DE 102006046193.2

(51) Int. Cl. G21K 5/10

(52) U.S. Cl. 250/396 R

(57) ABSTRACT

A particle therapy system is provided. The particle therapy system for particle therapy of a target volume of a patient includes a particle accelerator for furnishing high-energy particles; an adjusting device that adjusts a size of an irradiation volume; a control system for triggering the adjusting device, the control system outputting a control signal to the adjusting device. The control signal adjusts the three-dimensional size of the irradiation volume, so that during a time period in which the motion can be stopped, the entire target volume can be irradiated. The particle therapy system also including a scanner, which is triggerable in such a manner that the entire target volume with the irradiation volume can be scanned within the time period.

The present application claims the benefit of German Patent Application No. DE 10 2006 046 193.2 and U.S. Provisional Patent Application Ser. No. 60/848,602, both filed Sep. 29, 2006, which are hereby incorporated by reference.

### BACKGROUND

The present embodiments relate to a particle therapy system for irradiating a patient, and to a method for irradiating a patient.

A particle therapy system may include an accelerator unit and a high-energy beam guide system. The acceleration of the particles, such as protons, pions, or helium, carbon or oxygen ions, is done, for example, with the aid of a synchrotron. The particles, which are typically preaccelerated with a linear accelerator, are fed into the synchrotron to be accelerated to the desired energy and stored for the radiation treatment. Alternatively, the acceleration may be done via a cyclotron, in which various energies can be adjusted beginning at a maximum energy, for example, via suitable energy absorbers.

A high-energy beam transport system carries the particles from the accelerator unit to one or more treatment rooms. The particles strike the treatment site from a fixed direction in a fixed-beam treatment room. In a gantry-based treatment room the particle beam may be aimed at the patient from various directions.

With the aid of a grid scanner, the particle beam is moved over a scanning region. The beam is displaced laterally, for example, adjustably using two deflection magnets. The irradiation may be done in a volume element-oriented manner. For example, in therapy planning, the dosage distribution to be applied is composed of subdoses that are oriented to a volume element. Volume elements typically have dimensions of 2 to 3 mm (beam diameter and iso-energy layer thickness), so that the shape of the region to be irradiated, such as a tumor, may be tracked. The lateral dimensions are adjusted by the ion beam optics. The extent (dimension or size), or in other words the depth of the volume element (penetration depth), which is determined by the energy distribution of the beam, is adjusted by a suitable degrader, such as a ripple filter. The result is typical grid spacings of 2 to 3 mm in both the lateral direction and the direction of the penetration depth.

Therapy planning may provide for a subdivision of the irradiation process into a plurality of units. This subdivision may be geometric in nature; for example, it can be a subdivision into adjacent irradiation fields, whose size is defined by the maximum scannable irradiation field of the grid scanner. Alternatively, a subdivision may be made into chronological successive irradiation units, so as to achieve a corresponding effect over a plurality of radiation treatment sessions.

A control and safety system of the particle therapy system assures that a particle beam, with the desired parameters, is guided into the appropriate treatment room. The parameters are defined in the treatment plan, which indicates how many particles, from which direction, with what energy, are meant to strike the patient or each of the volume elements. The energy of the particles determines the penetration depth of the particles into the patient. For example, the maximum interaction with the tissue in the particle therapy takes place at the site of the volume element. The maximum dose is deposited at the site of the volume element. Accordingly, the energy distribution of the particle beam determines the dosage distribution in the incidence direction. Along with the beam profile, it accordingly determines the dimensions of an irradiation volume, given otherwise unchanged beam parameters. Beam monitoring elements may be located in front of the patient and monitor the position and/or intensity of the particle beam, for example. The position of the particle beam and its beam profile may be measured in transmission with the aid of suitable detectors, such as ionization chambers or multi-channel chambers that are located in the beam path close to the patient during the treatment.

A patient positioning device may be used to align the patient with the scanning region of the particle therapy system. For verifying the position for treatment of a preferably fixed patient, X-rays may be calibrated with CT data from the therapy planning before the radiation treatment is begun, and the patient is then readjusted if needed. Displacing the patient can enlarge the scannable region.

In radiation treatment by the grid scanning method, for example, the motion of a target volume or of volumes that radiation passes through adversely affects the homogeneity of the particle radiation applied; for example, see M. H. Phillips et al, “Effects of respiratory motion on dose uniformity with a charged particle scanning method”, Phys. Med. Biol. 1992, Vol. 32, No. 1, 223-224. From interference between the beam application and object motion, the applied dosage distribution and the planned dosage distribution no longer agree. The applied dosage distribution has discontinuities because of the motion; for example, the result is underdosage and/or overdosage.

The discontinuities may be reduced by multiple scanning of an energy layer at a reduced dose, since in that case the discontinuities are less in their intensity and are located at various points in the scanning region. However, a safety zone around the tissue to be irradiated must be provided that takes the amplitudes of the motion into account and assures that the tissue to be irradiated will be irradiated adequately. Adjoining energy layers may be differently affected by the motion, so that discontinuities in the Z direction, which is the direction of the incident beam, can result in addition.

Irradiating objects that move, for example, because of respiration, using motion-dependent gating of the treatment beam circumvents the effect of the motion by limiting the irradiation to quasi-stationary motion states, so that the lateral safety zone can be reduced. This kind of particle therapy system is known, for example, from S. Minohara et al, “Respiratory Gated Irradiation System for Heavy-ion Radiotherapy”, Int. J. Radiation Oncology Biol. Phys., Vol. 47, No. 4, pp. 1097-1103, 2000. Stopping the respiration similarly brings about quasi-stationary states, but, as in gating, discontinuities may still arise in the dosage distribution, especially in the transition region of adjoining energy layers.

### SUMMARY

The present embodiments may obviate one or more of the drawbacks or limitations inherent in the related art. For example, in one embodiment, the irradiation of moving objects in particle therapy by grid scanning is improved.

In one embodiment, a particle therapy system includes a particle accelerator for furnishing high-energy particles, an adjusting device for adjusting a size of the irradiation volume, a control system for triggering the adjusting device, and a scanner. The adjusting device, for example, representing the optics in the beam guidance of the particles and representing an adaptation device for adapting an energy distribution of the particles is triggered by the control system in such a way that a size of an irradiation volume is adjusted that makes it possible, during a time period within which a respiratory motion, for example, is stopped (or slowed down), to scan the entire target volume. In this scanning operation, at least one energy layer is irradiated with the irradiation volume in accordance with the course of the target volume.

The usual irradiation volumes in scanning methods, while they do enable good local resolution, require correspondingly long irradiation times, in which motions can adversely affect the homogeneity of the dosage distribution. Accordingly, the irradiation volume is adapted such that the entire target volume may be scanned even within a short period of time, so that in the radiation treatment, no limit courses arise in successive radiation treatments. A suitable absorber may broaden pencil beams of small cross section depthwise. For example, the energy distribution is broadened, for example, via a ripple filter, resulting in a broadened Brag peak zone in the incidence direction of the beam. Accordingly, only a few energy layers have to be irradiated, and this is possible within the time period. The local resolution in the lateral direction remains essentially unchanged. The beam is rapidly scanned in the lateral direction. The scanning speed is selected such that for the patient who is to be treated, the entire target volume is irradiated during a single phase while the patient holds his breath, for example. This process is repeated in each case, with the breath held, as often as needed until the required dose has been deposited in the target zone. Passive energy variation, for example, during a radiation treatment, can irradiate a plurality of required energy layers within one time period. Alternatively or in addition to the passive energy variations, the acceleration in the synchrotron may be varied.

This kind of particle therapy system makes it possible, albeit in quasi-stationary time periods, for example, in gating or when the breath is being held, for motion states that are not exactly identical to be irradiated, yet no underdosage or overdosage occur, since in successive time periods, neither energy layers nor lateral regions are placed against one another, so as to attain the desired dosage distribution. Accordingly, this kind of particle therapy system circumvents the disadvantage that individual irradiation points and regions and even energy layers do not fit together as desired. For example, if a scanning operation in each case takes place over the complete volume in the same patient state, deviations from the planned dose can occur only at the edge of the irradiation field. Within the target volume, no significant fluctuations in dosage occur. An additional enlargement, for example, broadening and/or deepening of the irradiation volume makes it possible to apply radiation to a complete field rapidly because of the reduced number of grid points and/or iso-energy layers.

In one embodiment, the ratio of the distal to the lateral dimension of the irradiation volume is greater than or equal to 2:1.

In one embodiment, the irradiation volume is adjusted to a size in the direction of the beam incidence that is at least 10% of the digital size of the target volume. This allows scanning of the target volume with ten, or preferably from five to three, iso-energy layers. For example, the distal size is in a range of approximately 5 to 25 mm.

In one embodiment, the scanner may be, for example, a grid scanner for a pencil beam or a wobbling device.

In one embodiment, a scanning method in which a target volume of a patient, the target volume being subjected to a (respiratory) motion, is to be irradiated with a particle beam, and an irradiation volume, in which particles interact with the tissue for therapy, is scanned over the target volume. In the method, the motion of the target volume is stopped (or slowed down), in order to create a quasi-stationary target volume within one time period. With irradiation volumes in the prior art, only a portion of the target volume could be irradiated in this time period. Accordingly, in one embodiment the irradiation volume is adjusted to a size that permits irradiating the entire volume that is to be irradiated during the time period. In this time period, the entire target volume to be irradiated is then scanned with the suitably adjusted irradiation volume, and the process is repeated often enough until the required dose has been applied. Using this method, discontinuities in the applied dosage distribution are avoided.

### BRIEF DESCRIPTION OF THE DRAWINGS

FIG. 1 illustrates one embodiment of a schematic particle therapy system;

FIG. 2 illustrates an arrangement of irradiation volumes in accordance with the prior art;

FIG. 3 illustrates a dosage distribution in the incidence direction;

FIG. 4 illustrates a subdivision of a target volume into irradiation volumes for irradiation within one time period;

FIG. 5 illustrates a dosage distribution in the incidence direction pertaining to FIG. 4; and

FIG. 6 illustrates a subdivision of a target volume into irradiation volumes, using broadening elements.

### DETAILED DESCRIPTION

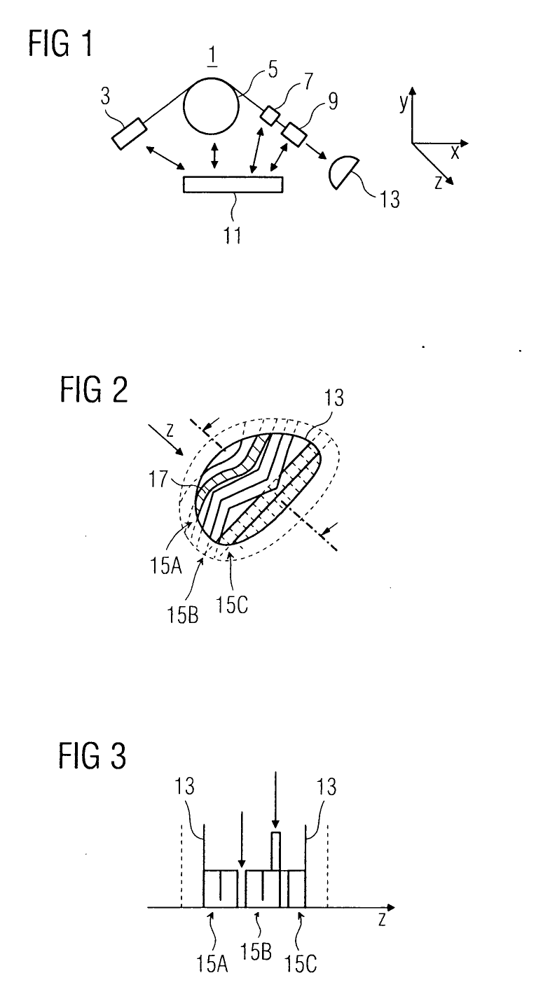

In one embodiment, as shown in FIG. 1, a particle therapy system 1 may include a preaccelerator 3, a synchrotron 5, and a scanner 7 in an adjusting device 9. A control system 11 adjusts the energy of the particles that are emitted from the synchrotron 5. The scanner 7 enables lateral deflections of the particle beam in the X and Y directions. The scanner 7 may be triggered, for example, by the control system 11. The adjusting device 9 is, for example, a set of broadening elements, such as ripple filters, which broaden the beam in its energy distribution, for example, by a factor of 1, 2, 4 and 8. Accordingly, irradiation volumes may be adjusted that are extended in the Z direction, for example, in the direction of the beam (distally) by a factor of 2, 4 or 8.

In one embodiment, irradiation volumes with extents in the X, Y and Z directions of 3 mm, 3 mm, and 2 mm, respectively, or 5 mm, 5 mm, and 3-5 mm, respectively, are used. The extents permit a contoured adaptation of the irradiated volume to the target volume 13 to be irradiated. For example, if the target volume is located in the vicinity of the lung, which moves during respiration, the location of the target volume 13 and of the tissue being scanned changes in the incidence channel of the particle beam. Accordingly, the course of an iso-energy layer also varies within one respiration cycle.

This is shown in FIG. 2 schematically in terms of three deformed pairs of iso-energy layers 15A, 15B and 15C in different states of motion. If these layers are irradiated, for example, in successive time periods, the result is discontinuities in the dosage distribution because of the overlap or absence of flush contact of the deformed iso-energy layers in the target volume 13. In FIG. 2, in the iso-energy layer 15A, a symmetrical irradiation volume 17 has been drawn in that it has dimensions of 3 mm in the lateral and Z directions, for example. The extent of the target volume 13 in the Z direction is, for example, eight iso-energy layer thicknesses. To compensate for motion displacements, a safety zone with a total thickness of one iso-energy layer around the target volume 13 is irradiated as well.

FIG. 3, for clarification of FIG. 2, shows how between the iso-energy layers 15A and 15B, for example, a non-irradiated zone remains, and how the energy layer 15B and the energy layer 15C are superimposed, resulting in twice the applied dose. Such discontinuities in the Z direction are not avoidable even by repeated (conventional) rescanning.

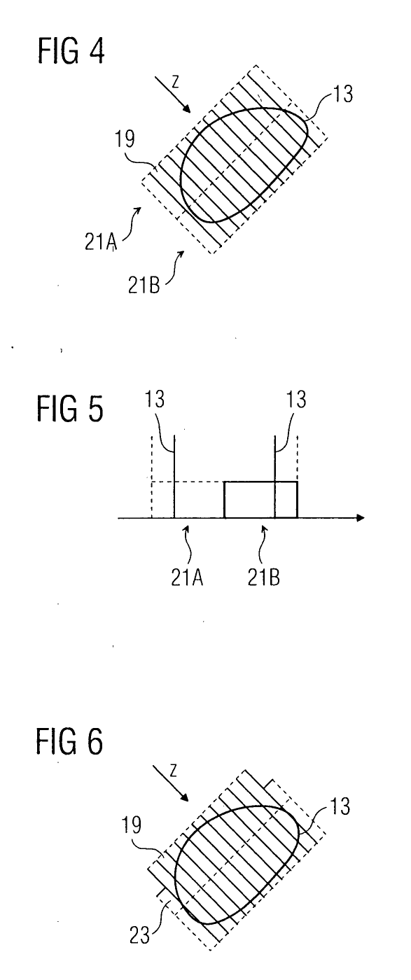

In one embodiment, as shown in FIG. 4, the broadening element 9 may be used to provide a subdivision of irradiation volumes 19 in the target volume 13. The subdivision of irradiation volumes 19 may include an irradiation volume 19 with four times greater a length in the Z direction than in the lateral direction, and a length in the Z direction of 12 mm, for example, and a lateral length of 3 mm. With this size of irradiation volume 19, the entire target volume 13 may be irradiated with two iso-energy layers 21A and 21B within one time period in which the (respiratory) motion is stopped. Accordingly, no variations in the dose occur in the irradiation, since the entire target volume is irradiated a single time under identical conditions.

In one embodiment, as shown in FIG. 5, no discontinuities caused by motion occur because of the irradiation of the entire target volume within one time period. The boundaries of the target volume 13 may be seen, and the interior may be irradiated homogeneously, with a surrounding safety zone, by the two iso-energy layers 21A and 21B.

A feasible time period for interrupting respiration, for example, is on the order of magnitude of 20 seconds, so that even relatively large target volumes may be scanned as a whole, if the number of iso-energy layers is reduced, for example, by a factor of 4.

In one embodiment, as shown in FIG. 6, a plurality of broadening elements 9 may be used so that the safety zone around the target tissue 13 need not be embodied as unnecessarily large. As a result of using the broadening elements 9, in a location-dependent way, for example, in the peripheral region, the extent of the irradiation volume in the Z direction may be reduced. In the peripheral region, instead of the irradiation volumes 19, which are extended by the factor of 4, irradiation volumes 23 may be extended by only a factor of 2. Broadening elements that differ as a function of location are introduced into the beam, or the acceleration/energy distribution is adapted accordingly.

If the target volume 13 is now irradiated multiple times as a whole all at once with this process, the result is a homogeneous dosage distribution over the target volume 13, even for particle therapy of moving targets by the scanning method.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A particle therapy system for particle therapy of a target volume of a patient, the target volume being subjected to motion, comprising:
a particle accelerator that is operable to provide high-energy particles;
an adjusting device that is operable to adjust a size of an irradiation volume, in which particles interact with the tissue for the therapy;
a control system that is operable to trigger the adjusting device and output a control signal to the adjusting device, which signal adjusts the three-dimensional dimensions of the irradiation volume, so that during a time period in which the motion can be stopped or slowed down, the entire target volume can be irradiated; and
a scanner that is triggerable so that the entire target volume with the irradiation volume can be scanned within the time period.

2. The particle therapy system as defined by claim 1, wherein the adjusting device includes an adaptation device that adapts an energy distribution of the particle beam applied, the energy distribution determining a distal extent of the irradiation volume.

3. The particle therapy system as defined by claim 1, wherein the adjusting device includes a high-energy beam guide that adapts the lateral dimensions of the particle beam applied by beam-guiding optics.

4. The particle therapy system as defined by claim 1, wherein the adjusting device is operable to adjust the irradiation volume to a distal-to-lateral ratio of the dimensions of greater than or equal to 2:1.

5. The particle therapy system as defined by claim 1, wherein the adjusting device is operable to adjust the irradiation volume to an extent in a direction of the beam incidence that has at least 10% of a distal extent of the target volume.

6. The particle therapy system as defined by claim 1, wherein the adjusting device is operable to adjust the irradiation volume to an extent in the direction of the beam incidence in the range of approximately 3 mm and 25 mm.

7. The particle therapy system as defined by claim 1, wherein the adjusting device is operable to adjust the irradiation volume to a lateral extent in the range of approximately 5 mm and 10 mm.

8. The particle therapy system as defined by claim 1, wherein the adaptation device is a degrader.

9. The particle therapy system as defined by claim 1, wherein the scanner is a grid scanner or a wobbling device.

10. The particle therapy system as defined by claim 1, wherein the particle accelerator is operable to adjust the energy for the irradiation of a plurality of energy layers within one time period.

11. The particle therapy system as defined by claim 1, comprising one or more adjusting devices that are operable to adjust the energy for the irradiation of a plurality of energy layers.

12. A scanning method for the particle therapy of a target volume of a patient, the target volume being subjected to motion, with a particle beam, wherein an irradiation volume in which particles interact with the tissue for the therapy is scanned over the target volume, the method comprising:
stopping or slowing down the motion of the target volume for a time period to create a quasi-stationary target volume;
adjusting the irradiation volume to a three-dimensional extent that allows irradiation during the time period of the entire volume to be irradiated;
scanning the entire target volume that is to be irradiated with the irradiation volume in the time period.

13. The method as defined by claim 12, comprising: adjusting the irradiation volume to a distal-to-lateral ratio of the dimensions of greater than or equal to 2:1.

14. The method as defined by claim 13, wherein the distal extent of the irradiation volume is greater than or equal to one-third the distal extent of the target volume.

15. The method as defined by claim 12, wherein the distal extent of the irradiation volume is in the range of approximately 5 mm and 25 mm.

16. The method as defined by claim 12, wherein the lateral extent of the irradiation volume is in the range of approximately 3 mm to 10 mm.

17. The method as defined by claim 12, wherein scanning the entire target volume to be irradiated comprises scanning at least one energy layer with the irradiation volume.

18. The method as defined by claim 12, wherein the scanning method is a grid scanning method or a wobbling method.

19. The particle therapy system as defined by claim 8, wherein the adaptation device is a ripple filter.
